(19) United States
(12) Patent Application Publication
(10) Pub. No.: US 2009/0308838 A1
(43) Pub. Date: Dec. 17, 2009

(54) METHOD OF MANUFACTURING REPRODUCING HEAD

(75) Inventor: Masanori Akie, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/360,578

(22) Filed: Jan. 27, 2009

(30) Foreign Application Priority Data
Jun. 13, 2008 (JP) 2008-155868

(51) Int. Cl. B44C 1/22

(52) U.S. Cl. 216/22

(57) ABSTRACT

The method includes the processes of: forming a magnetoresistance effect layer on a work; forming a mask layer on the magnetoresistance effect layer; forming a reproducing element section by etching a part of the magnetoresistance effect layer, in which the mask layer is not formed; forming an insulating layer so as to coat the reproducing element section and the mask layer on the reproducing element section; forming a bias layer and a cap layer on the insulating layer; etching specific parts of the cap layer and the bias layer until parts of the bias layer are exposed; forming a protection layer so as to coat the exposed parts of the bias layer; and flattening the entire surface, by reducing a height of the layered body including the above described layers, without re-exposing the exposed parts.

### CROSS-REFERENCE TO RELATED APPLICATION

This application is based upon and claims the benefit of priority of prior Japanese Patent Application No. 2008-155868, filed on Jun. 13, 2008, the entire contents of which are incorporated herein by reference.

### FIELD

The embodiment discussed herein is related to a method of manufacturing a reproducing head, more precisely relates to a method of manufacturing a reproducing head, which includes a magnetoresistance effect reproducing element.

### BACKGROUND

These days, storage capacities of storage units, e.g., magnetic disk unit, have been extremely increased. With significant increase of recording densities of magnetic recording media, further improvement of recording and reproducing characteristics of magnetic heads is required. For example, a reproducing head of a current magnetic head includes a giant magnetoresistance (GMR) element, which is capable of outputting high power signals, or a tunneling magnetoresistance (TMR) element, which has high reproduction sensitivity. On the other hand, a recording head of a current magnetic head, which includes an induction head using electromagnetic induction, has been developed.

In case that a CPP (Current Perpendicular to Plane) type magnetoresistance effect reproducing element, e.g., TMR element, is used in a reproducing head, if a magnetic state of a bias layer formed on the both sides of the magnetoresistance effect reproducing element is unstable, reproduced output will be fluctuated. Therefore, it is important to stabilize the magnetic state of the bias layer.

A method of manufacturing a reproducing head, which includes a CPP type magnetoresistance effect reproducing element, is disclosed in Japanese Laid-open Patent Publication No. 2007-5417.

### SUMMARY

According to an aspect of the embodiment, the method of manufacturing a reproducing head includes: forming a magnetoresistance effect layer on a work; forming a patterned mask layer on the magnetoresistance effect layer; forming a reproducing element section, whose end face on the air bearing surface side is formed into a rectangular shape or a trapezoidal shape, by etching a part of the magnetoresistance effect layer, in which the mask layer is not formed; forming an insulating layer on the entire surface of the layered body including the layers so as to coat the reproducing element section and the mask layer on the reproducing element section; forming a bias layer and a cap layer on the entire surface of the insulating layer in order; etching specific parts of the cap layer and the bias layer, which are located on the both sided of the mask layer on the reproducing element section, until parts of the bias layer are exposed; forming a protection layer on the entire surface of the layered body including the layers so as to coat the exposed parts of the bias layer; and flattening the entire surface of the layered body including the layers, by reducing a height of the layered body to a prescribed height, without re-exposing the exposed parts.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

Embodiments of the present invention will now be described by way of examples and with reference to the accompanying drawings, in which:

FIGS. 1A and 1B are explanation views showing an embodiment of the method of the present invention;

FIGS. 2A and 2B are explanation views showing further process of the embodiment of the method of the present invention;

FIGS. 3A and 3B are explanation views showing further process of the embodiment of the method of the present invention;

FIGS. 4A and 4B are explanation views showing further process of the embodiment of the method of the present invention;

FIGS. 5A and 5B are explanation views showing further process of the embodiment of the method of the present invention;

FIG. 6 is an explanation view showing further process of the embodiment of the method of the present invention;

FIG. 7 is a schematic view of a reproducing head manufactured by the method;

FIG. 8 is an explanation view showing a conventional method of manufacturing a reproducing head; and

FIG. 9 is a schematic view of the reproducing head manufactured by the conventional method.

### DESCRIPTION OF EMBODIMENTS

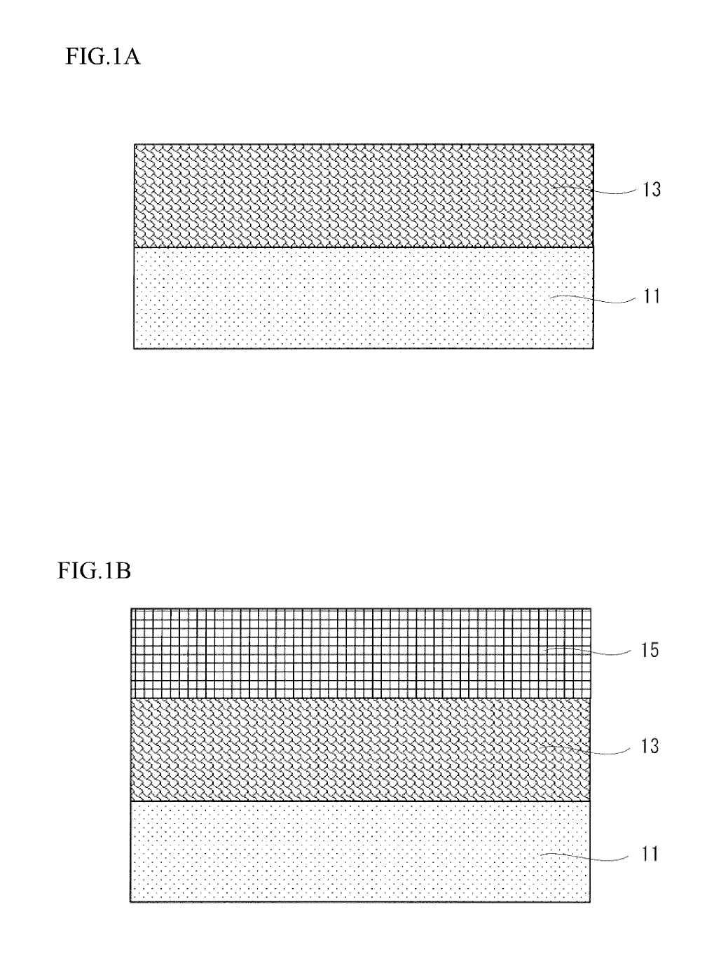

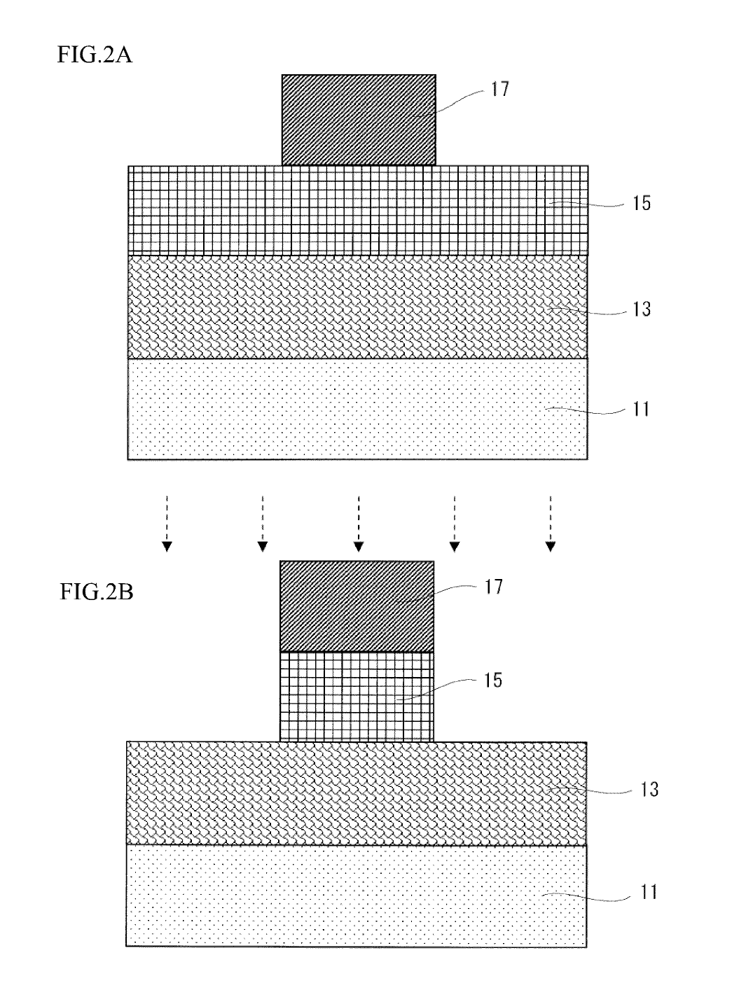

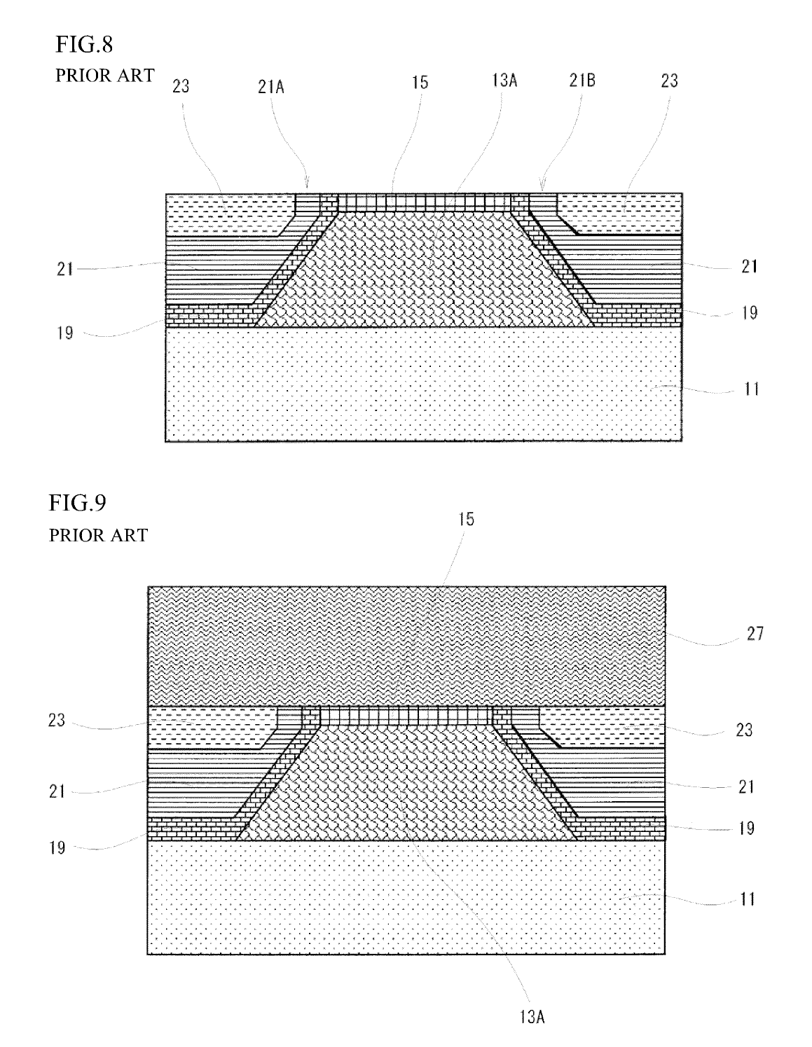

Preferred embodiments of the present invention will now be described in detail with reference to the accompanying drawings. FIGS. 1A-6 are explanation views showing an embodiment of the method of the present invention. FIG. 7 is a schematic view of a reproducing head manufactured by the method. FIG. 8 is an explanation view showing a conventional method of manufacturing a reproducing head. FIG. 9 is a schematic view of the reproducing head manufactured by the conventional method. Note that, each of the drawings shows a cross-section of an end part of the reproducing head, which is located near an air bearing surface. Arrows depicted in FIGS. 2B, 3B and 4B indicate etching directions.

A reproducing head 1 relating to the present invention reproduces magnetic signals recorded in a magnetic recording medium, e.g., hard disk. Note that, a recording head may be formed on the reproducing head 1 as a composite magnetic head.

A method of manufacturing the reproducing head 1 will be explained. Note that, a layered structure to be explained is an example, so the present invention is not limited to the following embodiment.

Firstly, as depicted in FIG. 1A, a lower shielding layer 11 is formed on a wafer substrate (not depicted), which is a base of the reproducing head 1. For example, the lower shielding layer 11 is composed of a soft magnetic material, e.g., NiFe. Note that, in each of the drawings, the air bearing surface is formed on the front side of the cross-section.

In the present embodiment, the layered structure from the wafer substrate to the lower shielding layer 11 is called a “work”. The layered structure of the work is not limited.

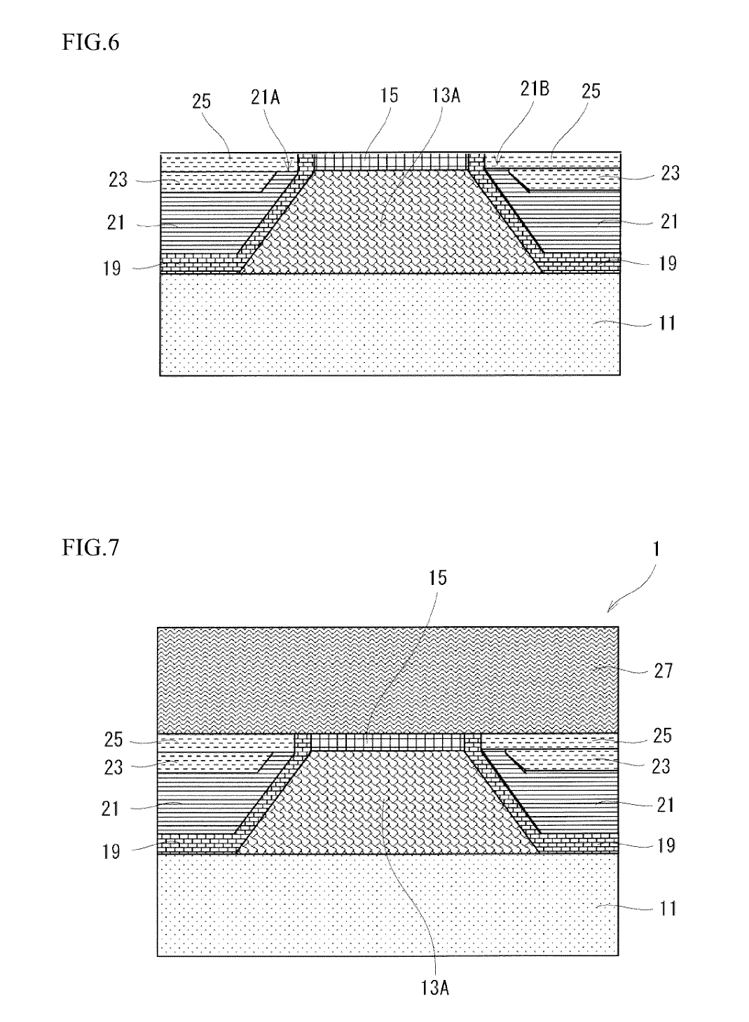

A magnetoresistance effect layer 13 is formed on the lower shielding layer 11. The magnetoresistance effect layer 13 has a multilayered structure and will be processed in the following processes so as to form a magnetoresistance effect reproducing element or a reproducing element section 13A (see FIGS. 6 and 7). The element may be a TMR element or a CPP-GMR element, but its film structure is not limited. In the present embodiment, a TMR element is employed as the magnetoresistance effect reproducing element.

In FIG. 1B, a mask layer 15 is formed on the magnetoresistance effect layer 13. For example, the mask layer 15 is composed of a metallic material, e.g., tantalum (Ta).

In FIG. 2A, a resist layer 17 is formed and patterned on the mask layer 15. For example, the resist layer 17 is composed of photo resist and formed into a desired pattern by a known photolithographic method. The resist layer 17 is formed in a region from which the mask layer 15 will not be removed in the following process.

In FIG. 2B, prescribed parts of the mask layer 15, which are not coated with the resist layer 17, are removed by an etching process. For example, a reactive ion etching (RIE) process may be employed as the etching process. Further, an ion beam etching (IBE) process may be employed.

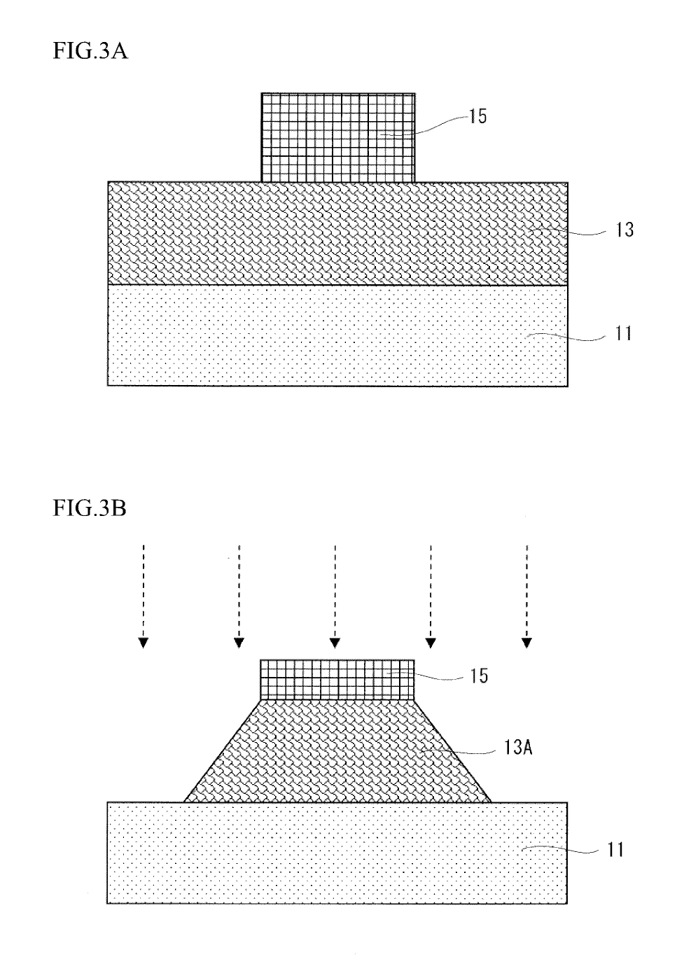

In FIG. 3A, the resist layer 17 left of the mask layer 15 is removed by, for example, a liftoff process.

In FIG. 3B, specific parts of the magnetoresistance effect layer 13, which are not coated with the mask layer 15, are removed by an etching process with using the mask layer 15, from which the prescribed parts have been removed, as an etching mask so as to form the reproducing element section 13A, which has a function of a reproducing element. For example, the IBE process is employed as the etching process. An end face of the reproducing element section 13A, on the air bearing surface side, is formed into a rectangular shape or a trapezoidal shape.

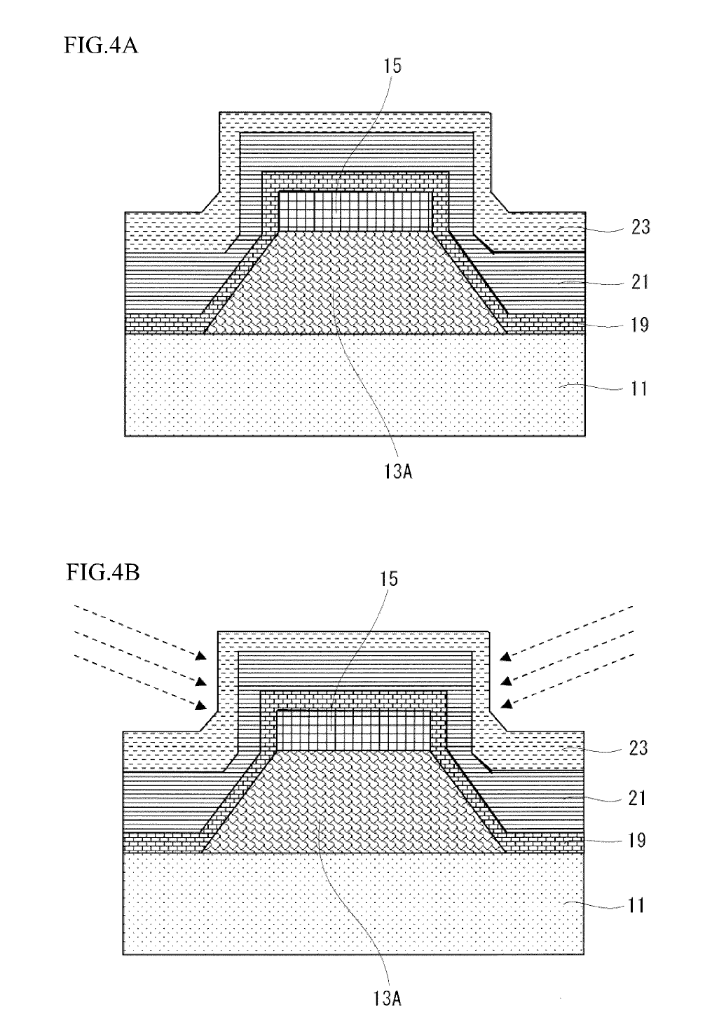

In FIG. 4A, an insulating layer 19 is formed on the lower shielding layer 11, the magnetoresistance effect layer 13 from which the specific parts have been removed, i.e., the reproducing element section 13A, and the mask layer 15 left on the reproducing element section 13A. For example, the insulating layer 19 is composed of an insulating material, e.g., Al₂O₃, and formed by sputtering.

A bias layer 21 is formed on the insulating layer 19. For example, the bias layer 21 is composed of a hard magnetic material, e.g., CoPt.

Further, a cap layer 23 is formed on the bias layer 21. For example, the cap layer 23 is composed of a metallic material, e.g., tantalum (Ta), ruthenium (Ru).

Note that, the above described processes are the same as those included in a conventional manufacturing method.

In the conventional manufacturing method, an upper surface is flattened by reducing a total height of a layered body to a prescribed height. For example, as depicted in FIG. 8, the entire upper surface is flattened by chemical-mechanical polishing (CMP) or a combination of etching and the CMP. Namely, the cap layer 23 on the reproducing element section 13A, the bias layer 21 and the insulating layer 19 are removed, and a mask layer 15 is abraded until reaching a prescribed thickness. Therefore, the upper surface is flattened by reducing the total height of the layered body.

Then, an upper shielding layer 27, etc. are formed on the flattened surface, so that the reproducing head (see FIG. 9) is completed. In the conventional method, parts other than the reproducing element section 13A are processed by the photolithographic method, which includes the processes of applying resist, exposing and developing, a dry etching process, etc.

While processing the parts, parts 21A and 21B of the bias layer 21 are exposed, in the flattened surface, on the both sides (the right side and the left side seen from the air bearing surface side) of the mask layer 15 (see FIG. 8). With this structure, a developing solution used in the developing process comes into contact with or invades into the exposed parts 21A and 21B of the bias layer 21 and the bias layer 21 will be damaged or deteriorated. By the damage or deterioration, a magnetic state of the bias layer 21 will be unstable.

On the other hand, the method of the present embodiment is capable of solving the problems of the conventional manufacturing method.

In the present embodiment, the process depicted in FIG. 4B is performed after the process depicted in FIG. 4A. Namely, the cap layer 23 and the bias layer 21 are etched. For example, they are etched by the IBE process.

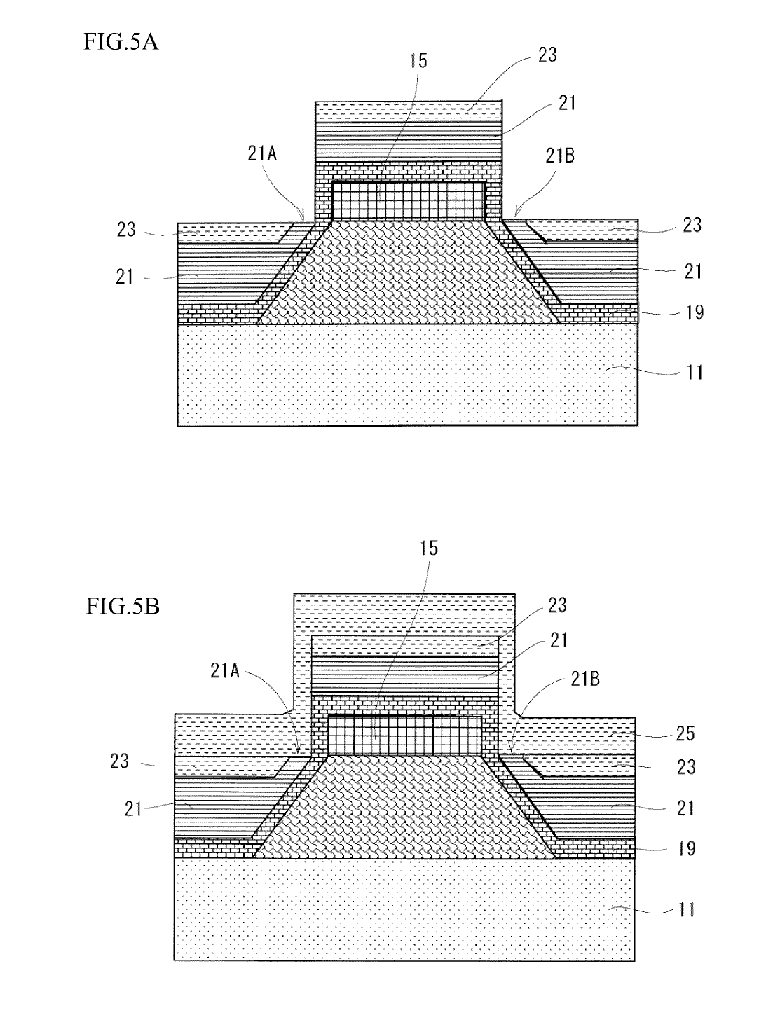

In the etching process, ion beams are emitted toward the layers (the cap layer 23, the bias layer 21 and the insulating layer 19), which are formed on the reproducing element section 13A and the mask layer 15, from diagonal upper positions, which are located on the both sides of the layers. With this process, the layers are formed as depicted in FIG. 5A.

As depicted in FIG. 5A, the parts 21A and 21B of the bias layer 21, which are respectively located on the right and the left sides of the mask layer 15 on the reproducing element section 13A when seen from the air bearing surface side, are exposed. Note that, in FIG. 5A, corners between the exposed parts 21A and 21B and the insulating layer 19 are perpendicularly formed, but the actual corners are not perpendicularly etched.

The etching is performed to make heights of the exposed parts 21A and 21B equal to that of an upper face of the reproducing element section 13A.

In FIG. 5B, a protection layer 25 is formed on the entire surface, so that the exposed parts 21A and 21B of the bias layer 21 are coated. Note that, the protection layer 25 may coat at least an entire surface of a prescribed region of a layered body including the above described layers. Namely, the entire surface of the layered body need not be completely coated with the protection layer 25.

For example, the protection layer 25 is composed of a nonmagnetic metal, e.g., tantalum (Ta), ruthenium (Ru), chrome (Cr), or an insulating material, e.g., Al₂O₃. Especially, in case that the protection layer 25 and the cap layer 23 are composed of the same material, e.g., Ta, a manufacturing cost can be reduced and process efficiency can be improved.

Further, as depicted in FIG. 6, the entire surface of the layered body is flattened, and a total height of the surface thereof is reduced to a prescribed height without re-exposing the parts 21A and 21B of the bias layer 21.

For example, a part of the protection layer 25, a part of the cap layer 23, a part of the bias layer 21 and a part of the insulating layer 19, which are formed on the reproducing element section 13, are removed, by the CMP or a combination of the CMP and dry etching. Further, the mask layer 15 is abraded until reaching a prescribed thickness. Therefore, the upper surface of the layered body is flattened by reducing the total height.

In this process, the heights of the parts 21A and 21B of the bias layer 21 are almost equal to that of the reproducing element section 13A. Since the mask layer 15 having the prescribed thickness is left, the parts 21A and 21B are not re-exposed in the surface of the layered body by the polishing process.

In the following process, parts other than the reproducing element section 13A will be processed by the photolithographic method, which includes the processes of applying resist, exposing and developing, a dry etching process, etc. However, as depicted in FIG. 6, the insulating layer 19 and the protection layer 25 are left, in the flattened surface, on the both sides (the right and left side seen from the air bearing surface side) of the mask layer 15. Therefore, the parts 21A and 21B of the bias layer 21 are not re-exposed, so that the damage or the deterioration of the bias layer 21, which is caused by chemicals for the development, plasma or ion beams for the etching, etc., can be prevented and the magnetic state of the bias layer 21 can be stabilized.

Finally, an upper shielding layer 27, etc. are layered to complete the reproducing head 1 (see FIG. 7).

As described above, by employing the method of the above described embodiment, the damage or deterioration of the bias layer, which badly influences output characteristics of the reproducing head and which is caused by chemicals, etching beams, plasma, etc., can be prevented, so that the magnetic state of the bias layer and the output characteristics of the reproducing head can be stabilized. Further, operational stability or reliability of a magnetic disk unit including the reproducing head can be improved.

Namely,with the method, even if the height of the layered body including the work is reduced to the prescribed height in the flattening process, the exposed parts of the bias layer are not re-exposed. Therefore, the bias layer is not damaged or deteriorated by chemicals, etc. while the reproducing head is manufactured, so that a magnetic state of the bias layer can be stabilized.

In the method, the flattening process may be performed by chemical-mechanical polishing or a combination of etching and chemical-mechanical polishing.

With the method, an upper face of the layered body on the work can be precisely flattened.

In the method, the etching process may be performed by ion beam dry etching, and ion beams are emitted toward the layers, which are formed on the reproducing element section and the mask layer, from diagonal upper positions on the both sides thereof.

With the method, the cap layer and the bias layer (including parts of the insulating layer) can be etched, so that the parts of the bias layer can be exposed at positions located on the both sides of the mask layer on the reproducing element section when seen from the air bearing surface side. Further, the layered body can be formed into a prescribed configuration, in which upper faces of the exposed parts can be level with an upper face of the reproducing element section

In the method, the protection layer may be composed of a nonmagnetic metallic material or an insulating material. Especially, the protection layer and the cap layer may be composed of the same material so as to reduce a manufacturing cost and improve process efficiency.

In the method of the present invention, damage or deterioration of the bias layer, which is caused by chemicals, etching beams, plasma, etc., can be prevented, so that the magnetic state of the bias layer and output characteristics of the reproducing head can be stabilized.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method of manufacturing a reproducing head, comprising:
forming a magnetoresistance effect layer on a work;
forming a patterned mask layer on the magnetoresistance effect layer;
forming a reproducing element section, whose end face on the air bearing surface side is formed into a rectangular shape or a trapezoidal shape, by etching a part of the magnetoresistance effect layer, in which the mask layer is not formed;
forming an insulating layer on the entire surface of the layered body including said layers so as to coat the reproducing element section and the mask layer on the reproducing element section;
forming a bias layer and a cap layer on the entire surface of the insulating layer in order;
etching specific parts of the cap layer and the bias layer, which are located on the both sided of the mask layer on the reproducing element section, until parts of the bias layer are exposed;
forming a protection layer on the entire surface of the layered body including said layers so as to coat the exposed parts of the bias layer; and
flattening the entire surface of the layered body including said layers, by reducing a height of the layered body to a prescribed height, without re-exposing the exposed parts.

2. The method according to claim 1,
wherein said flattening process is performed by chemical-mechanical polishing, or etching and chemical-mechanical polishing.

3. The method according to claim 1,
wherein said etching process is performed by ion beam dry etching, and
ion beams are emitted toward the layers, which are formed on the reproducing element section and the mask layer, from diagonal upper positions on the both sides thereof.

4. The method according to claim 2,
wherein said etching process is performed by ion beam dry etching, and
ion beams are emitted toward the layers, which are formed on the reproducing element section and the mask layer, from diagonal upper positions on the both sides thereof.

5. The method according to claim 1,
wherein the protection layer is composed of a nonmagnetic metallic material or an insulating material.

6. The method according to claim 2,
wherein the protection layer is composed of a nonmagnetic metallic material or an insulating material.

7. The method according to claim 3,
wherein the protection layer is composed of a nonmagnetic metallic material or an insulating material.

8. The method according to claim 4,
wherein the protection layer is composed of a nonmagnetic metallic material or an insulating material.

9. The method according to claim 1,
wherein the protection layer and the cap layer are composed of the same material.

10. The method according to claim 2,
wherein the protection layer and the cap layer are composed of the same material.

11. The method according to claim 3,
wherein the protection layer and the cap layer are composed of the same material.

12. The method according to claim 4,
wherein the protection layer and the cap layer are composed of the same material.

13. The method according to claim 5,
wherein the protection layer and the cap layer are composed of the same material.

14. The method according to claim 6,
wherein the protection layer and the cap layer are composed of the same material.

15. The method according to claim 7,
wherein the protection layer and the cap layer are composed of the same material.

16. The method according to claim 8,
wherein the protection layer and the cap layer are composed of the same material.
